(19) United States
(12) Patent Application Publication
(10) Pub. No.: US 2004/0088490 A1
(43) Pub. Date: May 6, 2004

(54) Super predictive fetching system and method

(76) Inventor: Subir Ghosh, San Jose, CA (US)

Correspondence Address: GRAY CARY WARE & FREIDENRICH LLP, 153 TOWNSEND, SUITE 800, SAN FRANCISCO, CA, 94107, US

(21) Appl. No.: 10/289,763

(22) Filed: Nov. 6, 2002

(51) Int. Cl. G06F 12/00

(52) U.S. Cl. 711/137; 711/218; 711/220

(57) ABSTRACT

A super predictive fetch system and method provides the benefits of a larger word line fill prefetch operation without the penalty normally associated with the larger line fill prefetch operation. Sequential memory access patterns are identified and caused to trigger a fetch of a sequential next line of data. The super predictive fetch operation includes a buffer into which the sequential next line of data is loaded. In one embodiment, the buffer is located in the memory controller. In another embodiment, the buffer is located in the cache controllers.

### TECHNICAL FIELD

This invention relates generally to a system and method for operating a computer system and in particular to a system and method for fetching data to be executed by a computer system.

### BACKGROUND OF THE INVENTION

In a microprocessor based system, a cache may be used to hold data that is used most often by the central processing unit (CPU). The utilization of the cache effectively increases the throughput of the system. In particular, the cache acts as a buffer between the faster CPU operations and the slower memory access operations. Without a cache system, the computer system's speed would be limited to it slowest component (e.g., the slower memory access speed) despite having a CPU that can operate much faster. The cache stores data that the CPU is likely to need to access (using various well known prediction algorithms) and operates as the same speed as the CPU. Since the cache is smaller than the memory system, it cannot hold all of the same data that is stored in external memory, and it relies upon predictions as to data most likely to be used by the CPU. The size of the cache and its organization (set associative, etc.) will determine the cache “hit” rate.

When an address is found in the cache (indicating that the desired data is in the cache—a cache “hit”), the data is provided to the CPU from the cache, and the CPU is able to continue operation at its full speed. In the case where the data requested by the CPU is not in the cache memory (a cache “miss”), a cache controller sends a memory request to the slower memory and adds wait states to the CPU. This will slow down the speed of the CPU (and cause a speed penalty) as it waits for the memory to provide the requested data. To keep the cost of the cache memory low, the cache typically has a tag RAM (a RAM that holds the addresses for later comparison to determine the cache hit/miss conditions) with fewer address bits than the maximum possible. As a result, instead of the byte/half word/word addresses that are normally available from the processor, the tag RAM contains the line addresses of the data in cache. A typical line in the cache may have multiple words associated with it, for example four (4) words or eight (8) words. Operating in “lines” of data provides a cost reduction and reduces the access time to the slower main memory system by prefetching a whole line of words in a burst to the cache subsystem instead of fetching each word separately. A bigger line size increases the probability of a cache miss, but also reduces the overall cost of the cache. Because tags are required for comparisons, a bigger line size means a smaller tag RAM size, but also a lower chance of a cache hit because of granularity—the number of additional words (potentially of no interest to the processor) which must be brought along in the line from memory in order to retrieve the word of interest. However, with bigger line size, a higher throughput from memory is possible because the retrieval can be done using a burst mode. To balance between the cost of the cache and the probability of a cache hit, the cache line may be set to four (4) words, for example. The smaller cache line size increases the penalty of consecutive memory accesses (a well known phenomenon known as locality of reference) in memory systems built with synchronous DRAM (SDRAM) or with pipelined burst synchronous SRAM (PBSRAM) because these well known memories have a lead-off latency associated with them. It is therefore desirable to provide a caching system and methodology that balances the line size granularity with the available bandwidth of the memory subsystem.

Among the microprocessor systems for which improved caching systems are of interest are those offered by ARM Limited of the United Kingdom. These are Reduced Instruction Set Computing (RISC) processors, such as the ARM7 and ARM9 families. The ARM7 and ARM9 processors are well known 32-bit processors with built in three-stage and five-stage pipelines, respectively. With these well known processors, if a pipelined read is enabled, an external data access operation has a one clock address phase with one or more clock data phases. During the data phase, the processor generally sends out the address for the next access. Since the next address is available, the cache controller is capable of supplying data on every clock when the data is resident in a cache (and provides a zero wait state access). In the case of a miss, the cache controller generates one or more wait states for the processor and requests the appropriate line from the memory subsystem. Once the line is available, the cache controller writes the line into the cache, updates the tag RAM and supplies the requested data to the processor. The processor and cache subsystem can run at a very high speed (for example, 150-200 MHz for ARM9, or 90 MHz for ARM7) while the memory subsystem can run at a different speed (for example, one half the processor speed for ARM9, or the same or one half the processor speed for ARM7). It is desirable to provide a technique for providing efficient cache operation in these and other similar types of processor systems. It is to this end that the present invention is directed.

### SUMMARY OF THE INVENTION

In accordance with the invention, a super predictive fetch system for use with a processor is provided comprising, a cache coupled to the processor, a cache controller coupled to the cache, a super predictive buffer, a memory controller coupled to the cache controller, and a main memory coupled to the memory controller. The super predictive buffer may reside in the cache controller or memory controller, and be used to hold data from a super predictive fetch. A super predictive fetch involves retrieving the next line of data from external memory when it is determined that the current requested word of data and the next requested word of data are found at sequential addresses. It is to be noted that the present invention involves the super predictive fetch of data associated with a line boundary based upon sequential addresses aligned to word boundaries. When the super predictive fetch turns out to be correct or successful, the line of data held in the super predictive data buffer is written into the cache and supplied to the processor. The invention brings in the next line into the cache only if the cache controller requests it.

The super predictive fetch system may be used in a single processor environment, or in a multiprocessor environment utilizing a cross-bar resource controller, a plurality of local memories and an AHB bus in order to achieve power reduction, and enhanced performance.

In operation, a processor issues a data read request for an external memory address, A, and during the data access portion of the data read request, makes available the next address, NA, for the next data read request. Based upon the address A, it is determined whether there is a cache hit for the requested data. Data is provided from the cache when there is a cache hit. In accordance with the invention, if the requested data is not in the cache a read request for the current address is first issued, then the cache controller determines if the next address is sequential. If the next address is not sequential, the cache controller issues a pipeline read of the data from the memory for a line of data, which begins at the next address. If the next address is sequential, then the cache controller increments the line address for the data currently being requested, and determines if the data for this next line address is already in the cache. If the data corresponding to the next line address is already in the cache, then no additional action is taken. If the cache does not contain the “next line” of data, the cache controller issues a pipeline read to the memory for the “next line” of data. During this super predictive fetch, the retrieved line may be loaded into the super predictive buffer. Thus, for example, two lines of data may be loaded or transferred to cache in an external memory access operation, one line having the word corresponding to the requested data, and the other line being the super predictive line of data. This means, for example, that for a cache system which employs a line size of four (4) words, when conditions specified for a super predictive fetch of the present invention are present, the system in fact may cause eight (8) words (two lines) of data to be loaded or transferred from memory, with a reduced latency penalty and even though the processor has requested only a few sequential words of data.

As the data read operation progresses for the next requested address that is not in cache, the cache controller may determine whether that requested data is found in the super predictive data, which preferably is being held in a super predictive buffer. If it is not in the super predictive data buffer (i.e., the prediction of the address of the next line was wrong), then the super predictive data may be discarded. If the requested address is located in the super predictive data buffer (i.e., the prediction was correct), then the requested data may be written into the cache by the cache controller and then provided to the processor. In this manner, the super predictive fetch method of the invention fetches two lines (e.g., eight (8) words) of data based on a prediction of a “next line,” which can reduce the likelihood of a cache miss as well as reliance on the slower main memory with attendant response latency penalty. Further, by initially holding the predicted line of data (e.g., four (4) words of data) in a buffer, instead of storing it immediately into cache, a more efficient use of cache capacity is achieved.

### BRIEF DESCRIPTION OF THE DRAWINGS

FIG. 1 is a diagram illustrating a conventional processor system with a cache memory and an external memory subsystem;

FIG. 2A is a diagram illustrating the relationships between byte, word, and line addresses in a four-byte-per-word, four-word-per-line cache architecture, as they relate to 16-bit and 32-bit memory subsystems;

FIG. 2B is a diagram illustrating a conventional cache and predictive fetch operation;

FIG. 2C illustrates an example of the fetching of lines of data from the memory subsystem at various address in connection with the fetch operation of FIGS. 2A and 3A;

FIG. 3A illustrates an example of access latencies in an external memory access operation from a 32-bit memory subsystem;

FIG. 3B illustrates an example of access latencies in an external memory access operation from a 16-bit memory subsystem;

FIG. 3C illustrates an example of access latencies in an external memory access operation from a 32-bit memory subsystem when sequential addresses are involved;

FIG. 3D illustrates an example of access latencies in an external memory access operation from a 16-bit memory subsystem when sequential addresses are involved;

FIG. 4 is a diagram illustrating a multi-processor system that may include a super predictive fetch system in accordance with the invention;

FIG. 5 is a flowchart illustrating a super predictive fetch method in accordance with the invention;

FIG. 6A illustrates a simplified example of the word and line boundary relationships involved in the super predictive fetching of lines of data from the memory subsystem in connection with the timing diagram of FIG. 6B;

FIG. 6B is a timing diagram illustrating a super predictive fetch method in accordance with the invention for a 32-bit memory case;

FIG. 6C is a timing diagram illustrating a super predictive fetch method in accordance with the invention for a 16-bit memory case;

FIG. 7 illustrates a first embodiment of the super predictive fetch system in accordance with the invention wherein a super predictive buffer is located in a memory controller; and

FIG. 8 illustrates a second embodiment of the super predictive fetch system in accordance with the invention wherein a super predictive buffer is located in a cache controller;

FIG. 9A illustrates the logical operations involved in the implementation of the super predictive fetch on one embodiment of the invention;

FIG. 9B is a timing diagram of the logical operations involved in the implementation of the super predictive fetch on one embodiment of the invention.

### DETAILED DESCRIPTION OF A PREFERRED EMBODIMENT

The invention is applicable to a dual processor ARM based computer system, and it is in this context that the invention will be described. It will be appreciated, however, that the system and method in accordance with the invention has broader utility, such as to other computer systems having one or more processors, and processors other than ARM processors, wherever it is desirable to provide a technique to reduce the penalty caused by consecutive cache misses.

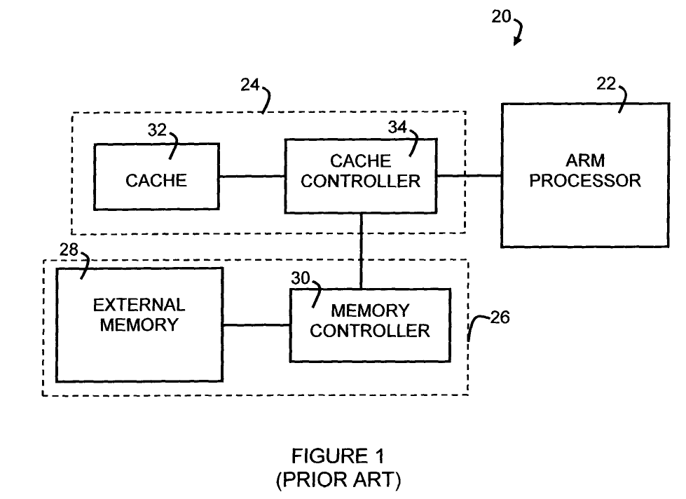

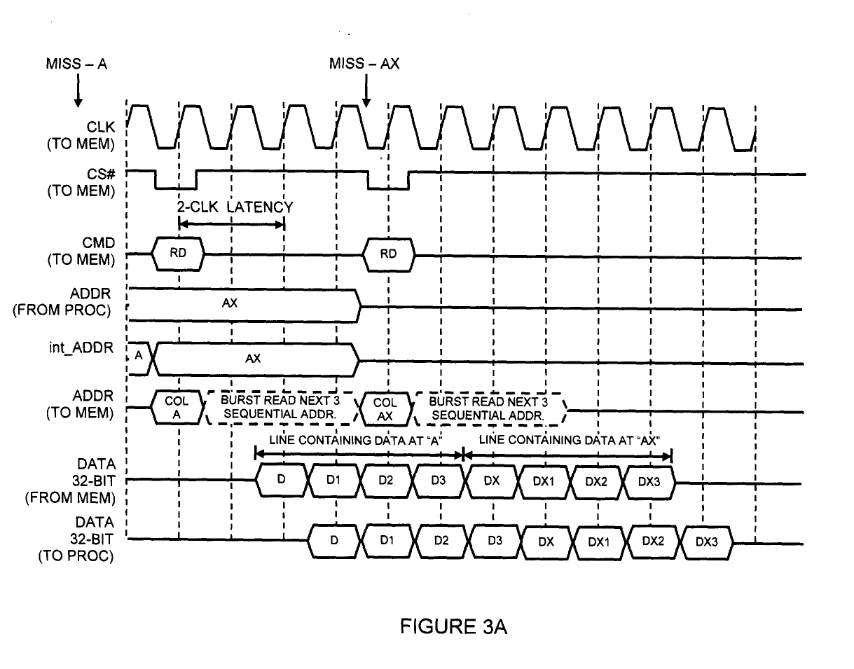

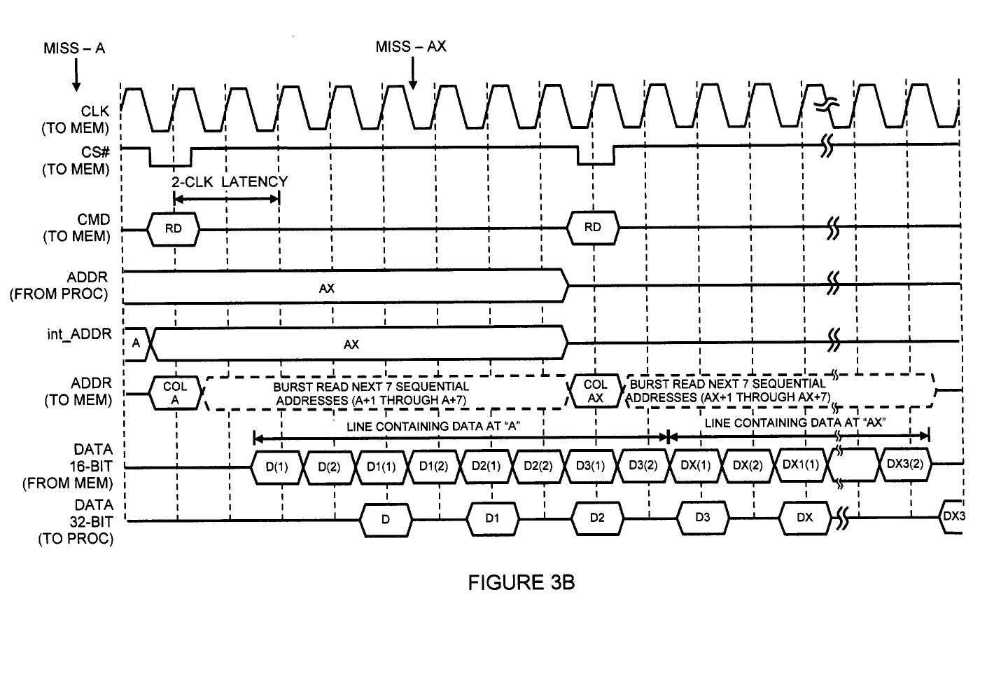

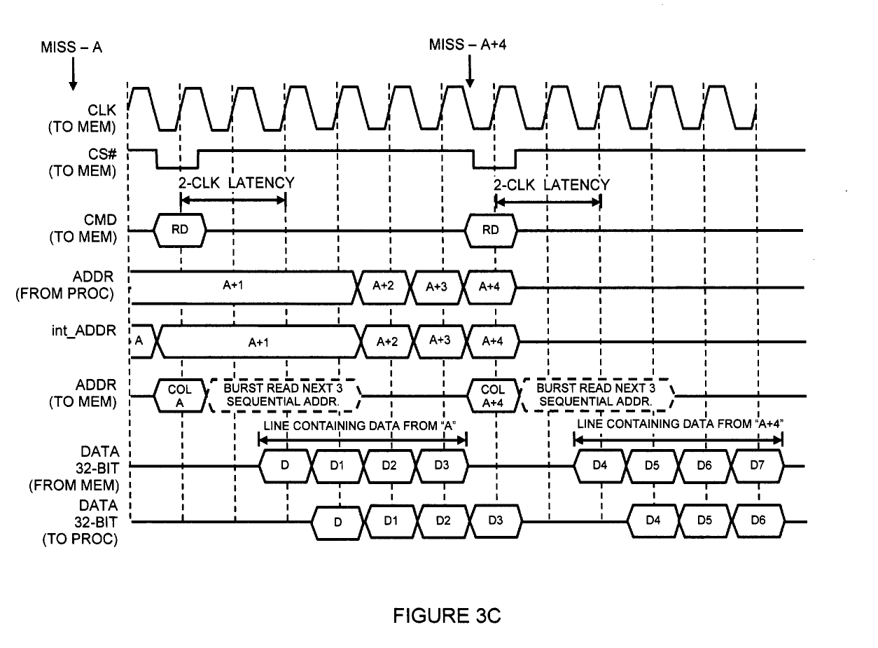

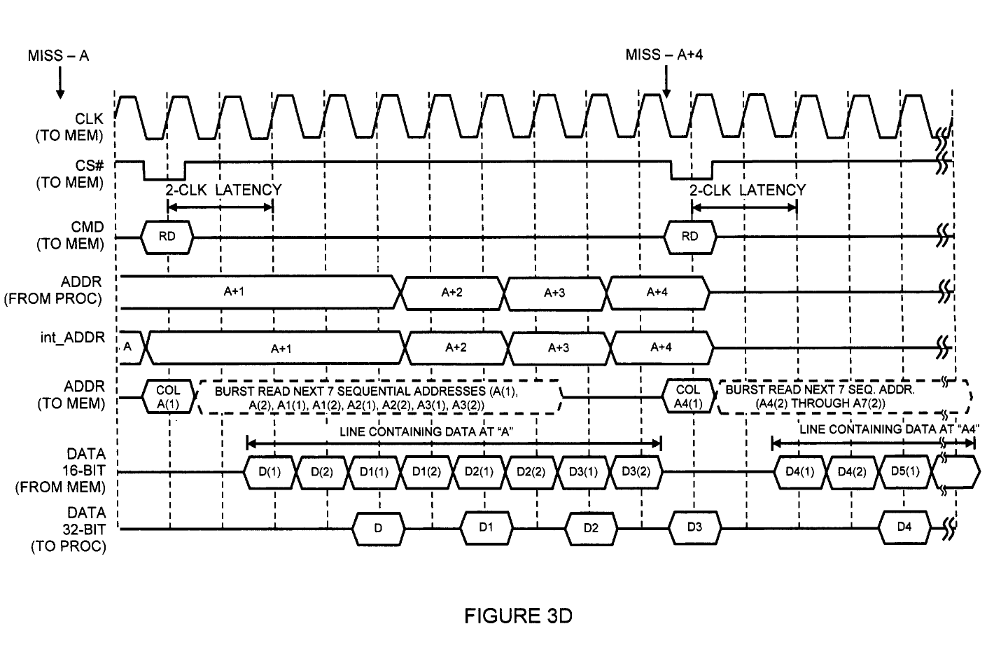

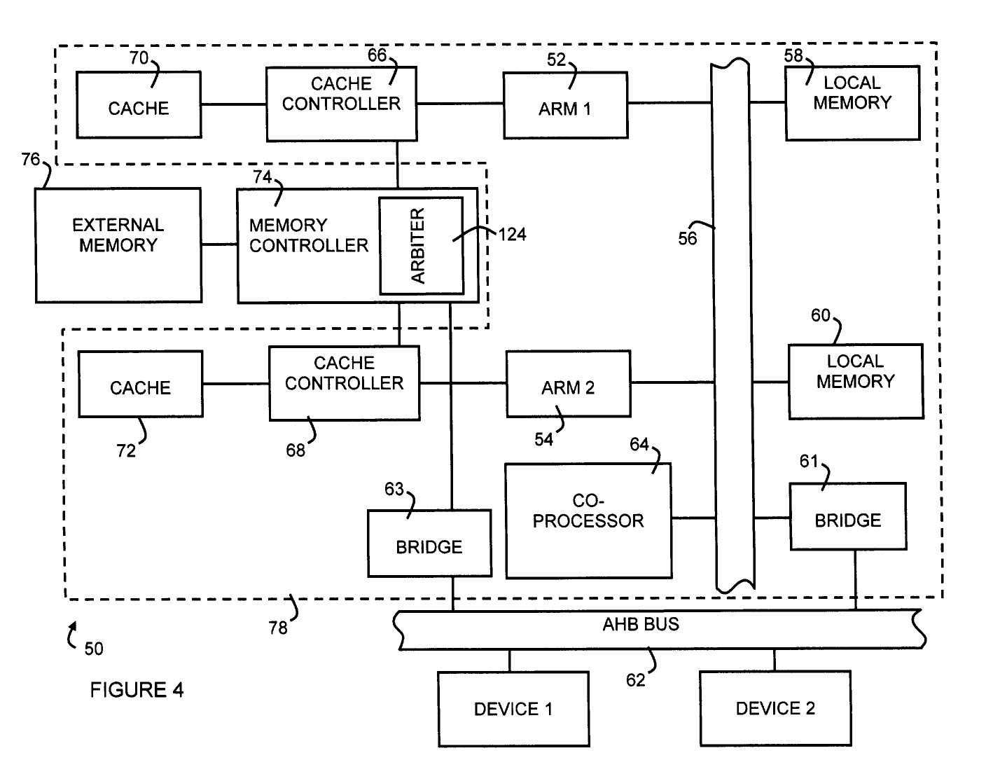

The conventional caching process and speed penalty will first be explained in greater detail in connection with FIGS. 1, 2A-2C, and 3A-3D. Thereafter, the invention will be described in the context of a multiprocessor computer system beginning with FIG. 4. It is to be understood that in order to simplify the timing diagrams of FIGS. 3A-3D, 6B, 6C, and 9B, for the CMD and ADDR lines in each of these figures, a single solid line is used between the command or address signals to indicate a “not valid” or “does not matter” state.

FIG. 1 is a diagram illustrating a conventional processor system 20 employing an ARM processor 22, a cache subsystem 24 and an external memory subsystem 26. As discussed earlier, the processor 22 and cache subsystem 24 may operate at a high speed, and the memory subsystem 26 may operate at a lower speed (for example ½ of the speed of the processor) which means that the processor may often wait (in response to wait states issued by the memory subsystem) for data from the memory subsystem 26. Also, response latencies in the memory subsystems result in further delays in retrieving data. Thus, in such a system, the processor cannot run at maximum speed and therefore the system cannot operate at peak processing speed.

To overcome the slow speed of the memory subsystem 26, a well known cache subsystem 24 is used which attempts to store the data more likely to be accessed by the processor 22 so that the processor does not have to wait for the slower memory subsystem 26. The memory subsystem 26 includes external memory 28 and memory controller 30. The cache subsystem 24 includes cache memory 32 and cache controller 34. External memory requests from processor 22 are received by cache controller 34. If necessary, cache controller 34 issues a request to memory controller 30 for data from external memory 28.

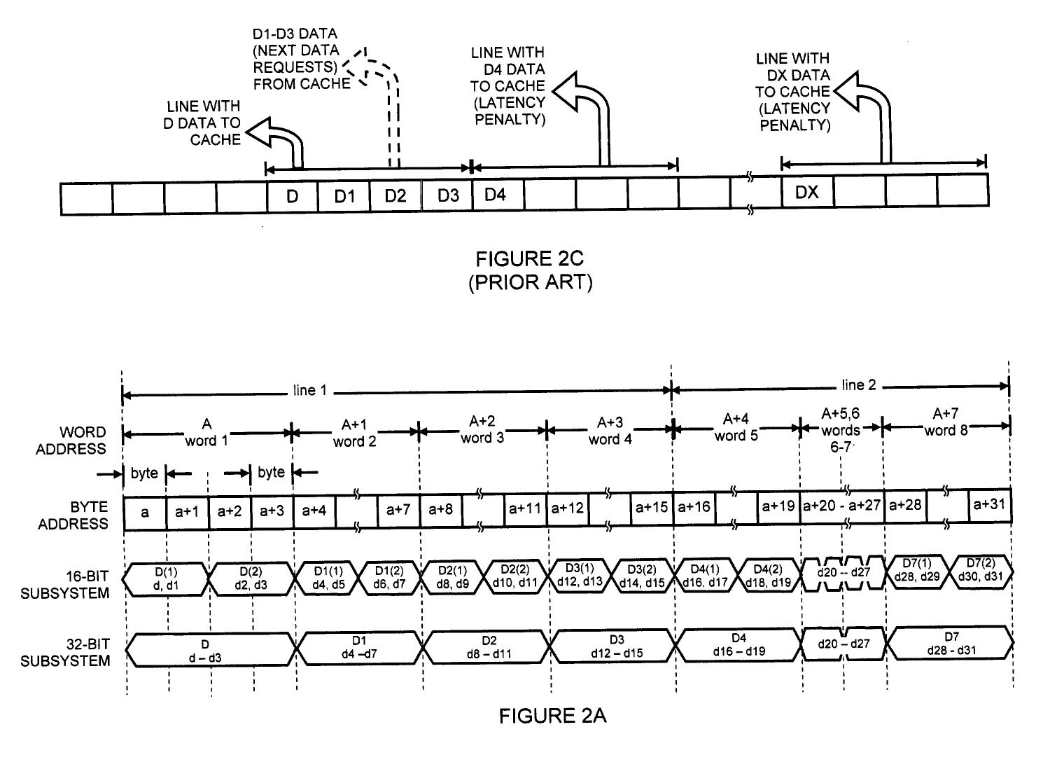

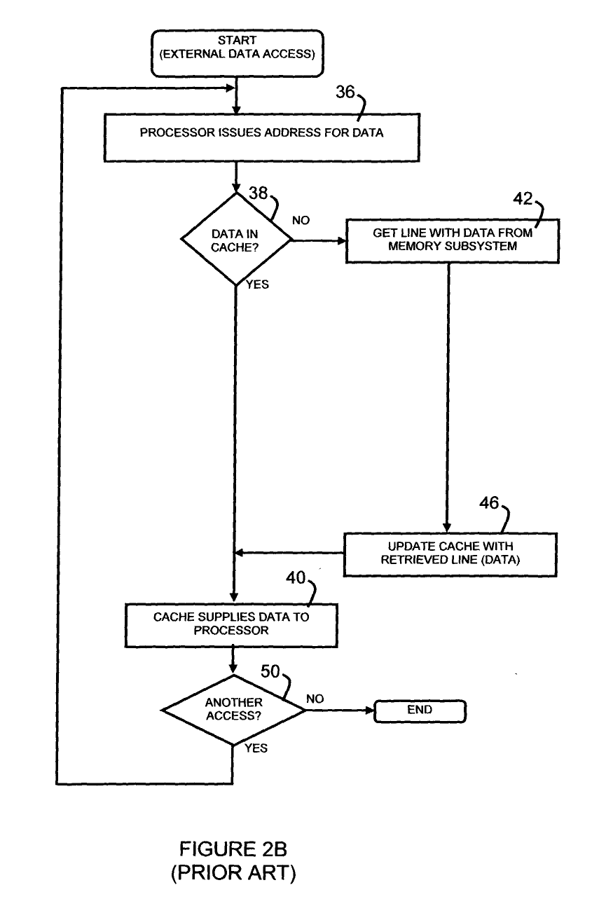

FIG. 2A illustrates the nomenclature and relationship between line size, word size and byte addressing for a four-word-per-line, four-byte-per-word cache architecture. It also illustrates the relationship of the data size in a 16-bit memory subsystem and in a 32-bit memory subsystem to the line size, word size and byte addressing relationships. Thus, from FIG. 2A it can be seen that a “word” of data (e.g. word 1 at address “A”) is made up of four bytes (e.g. at byte addresses a, a+1, a+2, and a+3). A line of data is made up of four “words” of data (e.g. at addresses A, A+1, A+2, and A+3). The next line of data will begin with word 4 at address A+4 and include the words at addresses A+5, A+6, and A+7.

For a 32-bit memory subsystem, 32 bits of data can be retrieved in one memory access cycle so that a “word” of data (e.g. D2 at word address A+2) consisting of four bytes of data (e.g. bytes d+8, d+9, d+10, and d+11 at byte addresses a+8, a+9, a+10, and a+11) is retrieved. In a 16-bit memory subsystem, only 16 bits of data can be retrieved at a time, therefore, two such access cycles are needed to retrieve one word of data (e.g. D2 at word address A+2). The first cycle retrieves the first half of the word (e.g. D2(1) containing bytes d8 and d9 of data at byte addresses a+8 and a+9), and the second retrieves the second half of the word (e.g. D2(2) containing bytes d10 and d11 of data at byte addresses a+10 and a+11).

The flow diagram of FIG. 2B illustrates the handling of external memory requests from the processor 22 in the conventional system of FIG. 1. At the start of an external memory request, the processor 22 issues the address for the requested data step 36. ARM processors have a built-in multi-stage pipeline, so that following the address portion of an external memory request, the next address for the next data becomes available from the processor at the next clock cycle. (In the ARM7 processor the next address becomes available as described above when pipelining is enabled.)

Upon receipt of an external memory request, cache subsystem 24 checks to see if the requested data is already in the cache memory 32, step 38. If the requested data is already in cache (a “hit”), the cache controller 34 supplies the requested data to processor 22 from cache memory 32 at the processor speed, step 40. On the other hand, if the requested data is not in cache (a “miss”) the cache controller 34 will retrieve a line of data containing the requested data from the memory subsystem 26, step 42, and incur a speed penalty due to the response latency and slower speed of the memory. This process of first checking cache, and then retrieving a line of data from memory 32 if the data is not in cache, is repeated for the next requested data, and a speed penalty is again incurred if an access to memory 32 is required and the cache controller is not able to request the next data in a pipelined read.

FIG. 2C illustrates the above retrieval process for the situation where data D, D1, D2, D3 and D4, located at sequential addresses A, A+1, A+2, A+3, and A+4, respectively, are requested. Also illustrated is an operation where data DX, located at a non-sequential address, AX, is requested following the request for data D at address A. In the example of FIG. 2C, each box represents a word of data at a particular address, and eighteen (18) word addresses in memory 32 are represented.

From FIG. 2C, it can be seen that a memory access for current requested data D results in retrieval of data D within a line of data, in this case four words wide, from memory 28 by the cache subsystem 34. Although a lead-off latency penalty is incurred for data D, the rest of the data (D1, D2 and D3) in the line are brought into the cache as part of a burst read from memory 32, and are not subject to the lead-off latency delay. When the cache controller processes the request for the next word at A+1, no memory access is required because the word at A+1 (D1) was brought into the cache as a part of the previous retrieval of word D at address A. Similarly, the subsequently requested words located at sequential addresses A+2 and A+3 (data D2 and D3) are available from cache because they were stored in cache as a part of the line of data obtained when data D was retrieved. However, it is to be noted that the last requested data in that sequence, D4, located at address A+4, was not among the data retrieved with data D, and may require a memory access from memory 28 in which a lead-off latency penalty is again incurred, even though it is located at a sequential address. This is because, by the time address A+4 is received for processing by cache controller 34, the previous memory access involving the line containing data D will have been completed and no pipelined read can be made. For the data DX, which is located at an address AX many positions removed from A, FIG. 2C shows that a memory access is required which will incur a lead-off latency penalty. However, the three additional words in the line containing DX will be retrieved in a burst mode, and should they be subsequently requested, a lead-off latency penalty will not be incurred.

Thus, returning to FIG. 2B, in a conventional system, following the retrieval of the requested data (D) from memory subsystem 26, step 42, the cache 32 is updated with the retrieved line of data, which includes requested data D, step 46. Then the cache supplies the requested data D to the processor, step 40, and if more data is requested, step 50, the cache controller returns to step 36. (It is to be noted that the above updating of cache and data transfer to the processor may happen concurrently.) Assuming more data are in fact being requested (at sequential addresses A+1, A+2, A+3 and A+4) in step 36, the cache controller 34 examines the next address (A+1) for the next data request that has become available from processor 22 to determine if the next data (D1) is found in cache, step 38. Because next data (D1) is in cache, next data D1 is supplied from cache, and no further action to access the memory subsystem is taken. Cache controller 34 then proceeds to step 40 where requested next data (D1) is issued to processor 22. Steps 36, 38, 40 and 50 are then repeated for addresses A+2 and A+3, corresponding to data D2 and D3, respectively. However, for address A+4, assuming that the data at A+4 was not previously stored in cache, a new memory access will be required, step 42. A lead-off latency penalty will thus be incurred when retrieving data D4 at address A+4. Therefore, in this situation, even though the addresses for data D, D1, D2, D3 and D4 were all sequential addresses, lead-off latency penalties were incurred for data D and D4.

As mentioned above, the speed penalty incurred when data is retrieved from external memory 28 has several components: the typically lower operating speed of external memory, and lead-off latency, such as is found in Synchronous DRAM (“SDRAM”) or Pipelined Burst Synchronous SRAM (PBSRAM), and the like. Memories without lead-off latency, if available, will be typically very expensive. FIGS. 3A and 3B illustrate the lead-off latency component of this speed penalty, as well as timing differences between 32-bit and 16-bit memory systems. As can be seen from FIG. 3A, there is a two clock-cycle delay or latency following receipt by external memory 28 of the address “A”, the Read (RD) command (CMD), and chip select (CS#), before the data “D” becomes available for transmission to processor 22. Note in FIG. 3A that in addition to “D,” data words “D1” through “D3” are also retrieved as a part of a “four-word line” of data in a “burst” operation from memory 28. It is also to be understood that the two clock-cycle delay shown in FIG. 3A is merely illustrative, and that other lead-off latencies are found in the external memory devices in current use, for example, a lead off latency of three clock-cycles is common. Also, the number of words in a “line” need not equal four (4), for example, eight-word lines are sometimes used.

Remaining with FIG. 3A, it is also to be appreciated that depending upon the timing of when the “next address” for the “next data” becomes available from processor 22, the pipelined read capabilities of the memory 28 may or may not be available. FIG. 3A illustrates the situation where next address “AX” becomes available and is applied to memory 28 two clock cycles before the end of the data burst associated with address “A,” so that a pipelined read operation may be carried out. Because of this, the next data “DX” corresponding to next address “AX” is supplied immediately following the end of the data burst associated with address “A.” On the other hand, if next address “AX” were supplied after the burst associated with address “A” terminated, a new read cycle would need to be initiated and another two clock-cycle latency penalty would be incurred before next data “DX” would be available. It is to be noted that FIG. 3A shows a pipelined read of next data at address AX and a burst read of the next three requested addresses so that the line of data beginning at address AX is brought into cache.

Referring now to FIG. 3B, a timing diagram is provided for the case of a 32-bit processor and a 16-bit memory system. Each 32-bit word, for example D, to be retrieved from memory 28 requires the reading of two 16-bit half-words from memory 28. Thus, in addition to the two-clock cycle access latency for SDRAM or PBSRAM memories, there is a further one clock cycle delay incurred for each requested 32-bit word. Thus, retrieval of a four-word line from memory will require eight (8) clocks for the 16-bit memory system of FIG. 3B, compared with the four (4) clocks for the 32-bit memory system illustrated in FIG. 3A.

FIGS. 3C and 3D illustrate the speed penalty incurred in a conventional system when sequential addresses are being accessed for 32-bit and 16-bit memory subsystems, respectively. Thus, for the 32-bit case illustrated in FIG. 3C, even though the data to be retrieved are located at sequential addresses A, A+1, A+2, A+3, and A+4, there is a multi-clock-cycle speed penalty incurred between receipt by the processor of data D3 and data D4.

As will be hereinafter described in greater detail, the super predictive fetch cache system of the invention provides a methodology which takes advantage of a portion of these speed penalties to identify sequential accesses and to retrieve a sequential next line of data, to thereby save time in connection with subsequent accesses to external memory.

FIG. 4 is a diagram illustrating a dual processor system 50 that may include a super predictive fetch system in accordance with the invention, The system 50 may include a first processor 52 and a second processor 54 which are connected together to permit inter-processor communications as is described in more detail in co-pending U.S. patent application Ser. No. 09/849,885 filed on May 2, 2001 and entitled “Multiprocessor Interrupt Handling System and Method” which is hereby incorporated by reference. The system may include a cross-bar resource controller 56 as shown that connects the two processors and various other components of the system. The cross-bar resource controller is described in more detail in copending U.S. patent application Ser. No. 09/847,991, filed on May 2, 2001 and entitled “Cross Bar Multipath Resource Controller System and Method” which is incorporated herein by reference. The system 50 further comprises a first and second local memory 58, 60 that are connected to the cross-bar resource controller 56, an AHB bus 62 connected to the cross-bar resource controller through a bridge 61, and a coprocessor 64 that is also connected to the cross-bar resource controller.

The AHB or “Advanced High-Performance Bus” is a well known on-chip bus that is licensed by ARM, Limited (http://www.arm.com/) of the United Kingdom. The AHB bus 62 is shown in FIG. 4 as being coupled to the cross-bar resource controller 56 through a bridge 61. Other devices, such as Device 1 and Device 2, are shown being coupled to the AHB bus 62. A bridge 63 couples AHB bus to memory controller 74 to provide access for Device 1 and Device 2 to external memory 76.

The processors 52 and 54 can be ARM processors, such as the ARM7 or ARM9 processors. These processors are commercially available from ARM, Limited. Also, other processors such as MIPS processors can be employed.

The system 50 may further include a first cache controller 66 associated with the first processor 52 and a second cache controller 68 associated with the second processor 54 that controls access to a first cache 70 and a second cache 72, respectively, wherein the caches operate in a well known manner. Each cache controller is connected to its cache as shown and is also connected to a memory controller 74, which is in turn connected to an external memory 76. Generally, the cache controllers control access to the caches and interact with the memory controller, while the memory controller controls access to the slower external memory 76. As shown by a dotted line 78, the components of the system, except for the memory controller 74 and the external memory 76, are driven by the same clock signal so that all of the components operate at the same high speed as the processors and cache. Depending upon the frequency of operation, the memory controller and the external memory 76 may operate at the same clock rate.

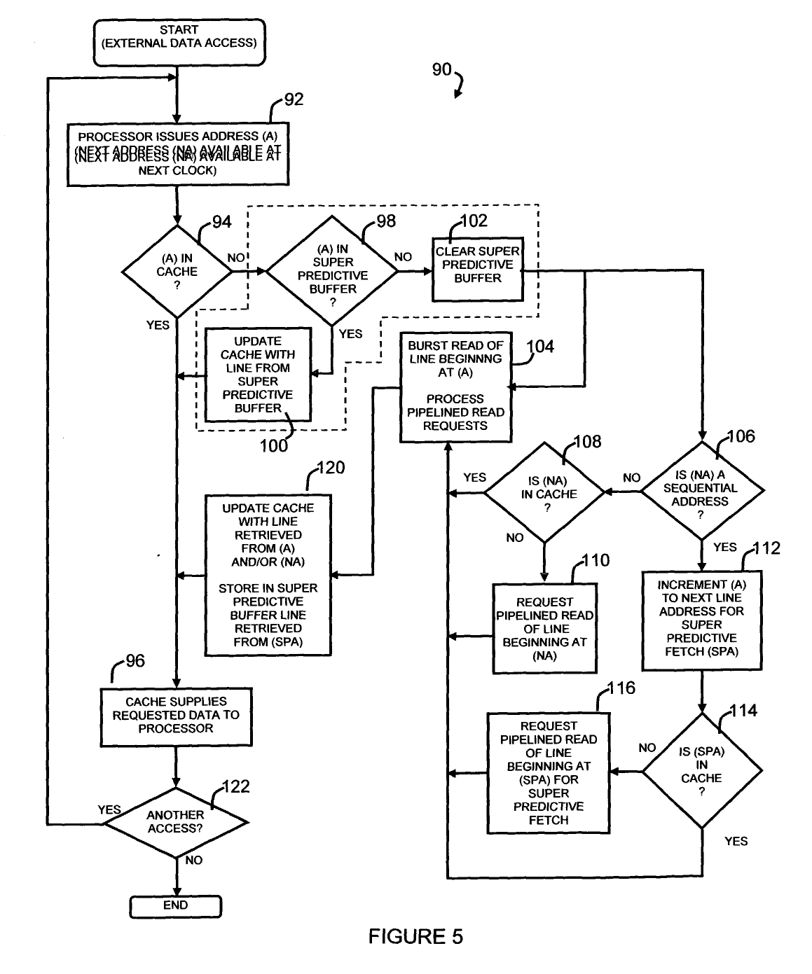

Through the use of the computer system architecture of FIG. 4, some of the limitations of the typical ARM-based systems are obviated and overcome. However, the above system still suffers from the speed penalty associated with cache misses. A super predictive fetch system in accordance with the invention overcomes these limitations and reduces the penalty associated with a cache miss situation. The super predictive fetch system in accordance with the invention will now be described in connection with FIG. 5.

FIG. 5 is a flowchart illustrating a super predictive fetch method 90 in accordance with the invention. In describing this flow chart, reference numbers will be used for the system components which are associated with ARM processor 52 in FIG. 4. However, it is to be understood that the following explanation is equally applicable to ARM processor 54 and its associated components.

In step 92, of FIG. 5, the processor 52 requests data (D) at address (A), and at the next clock, the next address (NA) for the next word of data (ND) becomes available. In step 94, the cache controller 66 determines if the current data requested, (D), is in the cache 70 by checking to see if the address (A) is in its tag list.

If the requested data is in the cache 70 (a cache “hit”), the data is provided to the processor 52 from the cache (through the cache controller 66) in step 96. Thereafter, in step 122, it is determined whether the processor 52 is requesting another external memory access. If so, step 92 is repeated. If not, the external data access is ended. On the other hand, if in step 94 above, the current requested data, (D), was not in cache 70 (a cache “miss”), the data will be retrieved from external memory 76 in step 104. To this point, the steps described are conventional cache accessing steps.

In accordance with the invention, in step 94 if the requested data is not in the cache 70, the cache controller 66 first determines if the current requested data, (D), is in a super predictive buffer, step 98. If so, the cache 70 is updated with the contents of the super predictive buffer, step 100, and the current requested data, (D), is supplied from the updated cache in step 96. The significance of steps 98 and 100 will become clearer upon considering the remaining steps of FIG. 5.

On the other hand, in step 98, if the current requested data, (D), is not in the super predictive buffer, the super predictive buffer is cleared, step 102, and the cache controller 66 initiates a burst read from external memory 76 of a line of data beginning at the address, (A), for the current requested data, (D), step 104. The requested burst read will retrieve the words at address A, A+1, A+2, and A+3, so that a line of data is retrieved.

While the burst read of current requested data, (D), is proceeding, the cache controller 66 examines the next address, (NA), to determine if it is a sequential address, step 106, which would indicate that a sequential read may be underway. (In the case of an ARM-specific implementation, the SEQ signal (Sequential Address) from the ARM processor can be used to indicate that the next address will be a sequential address. An alternate implementation may use comparator logic to compare the next address with the first address which has been incremented.) If the next address, (NA), is not sequential the cache 70 is checked to see if it contains the next address, (NA), step 108. In the event next address, (NA), is found in the cache 70, no further action is taken for that address and the burst read from external memory 76 of current requested data, (D), proceeds to completion in step 104. Conversely, if next address, (NA), is not found in the cache 70, a pipelined burst read is issued in step 110 so that a line of data beginning at next address, (NA), is read out of external memory 76 in step 104 immediately following the line of data containing current requested data, (D). The pipelined read of steps 108 and 110 is like the prior art and is illustrated in FIGS. 3A and 3B for the next address AX.

On the other hand, if in step 106 above, the next address, (NA), is determined to be sequential, the cache controller 66 increments the line address for the current requested data, (D), and checks to see if the next line address is in the cache 70, step 114. This next line addressed is denoted by “SPA” in step 114 to represent a super predictive fetch address. For example, assuming a four-word line, and that the address for the current requested data is A, the address for the SPA next line of data would be A+4. If SPA is already in the cache 70, as determined in step 114, then no further action is taken for that address and the read from external memory for current requested data, (D), proceeds to completion in step 104. However, if SPA is not already in the cache 70, then the cache controller 66 initiates a pipelined burst read from external memory 76 of the SPA next line of data, step 116, and the pipelined burst read is handled in step 104. This makes available to the cache 70, in the event the processor requests it, a line of data which is beyond the line of data in which the next data, (ND), is found.

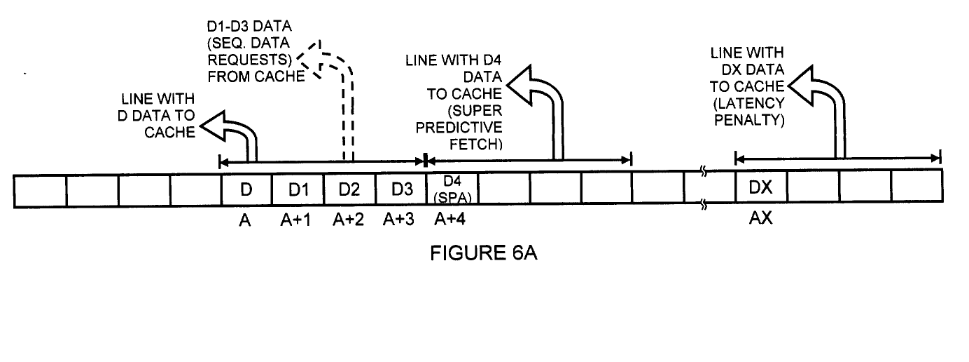

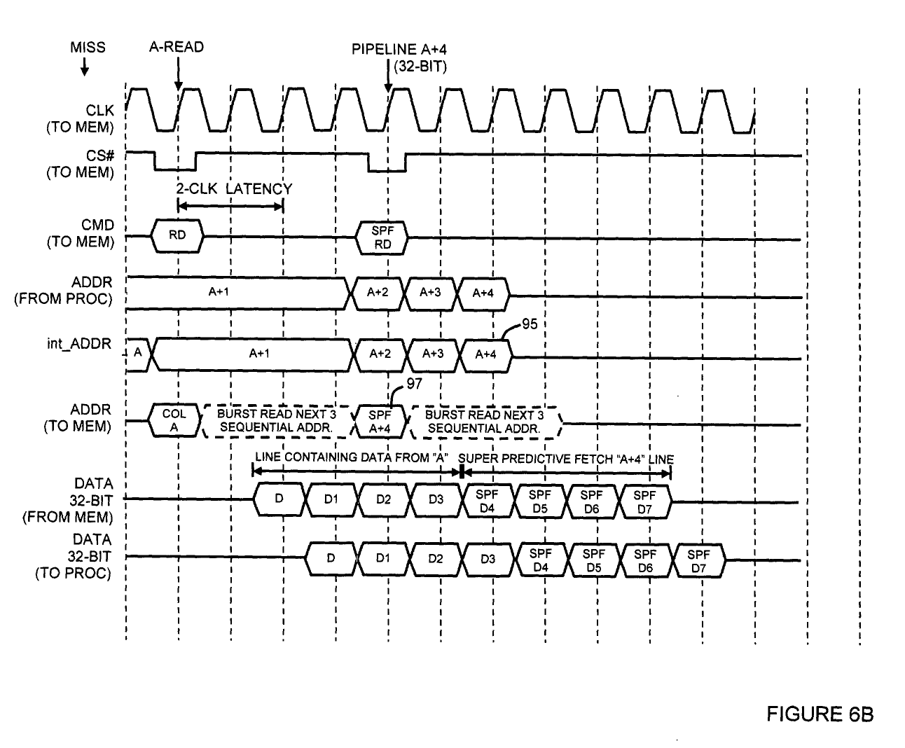

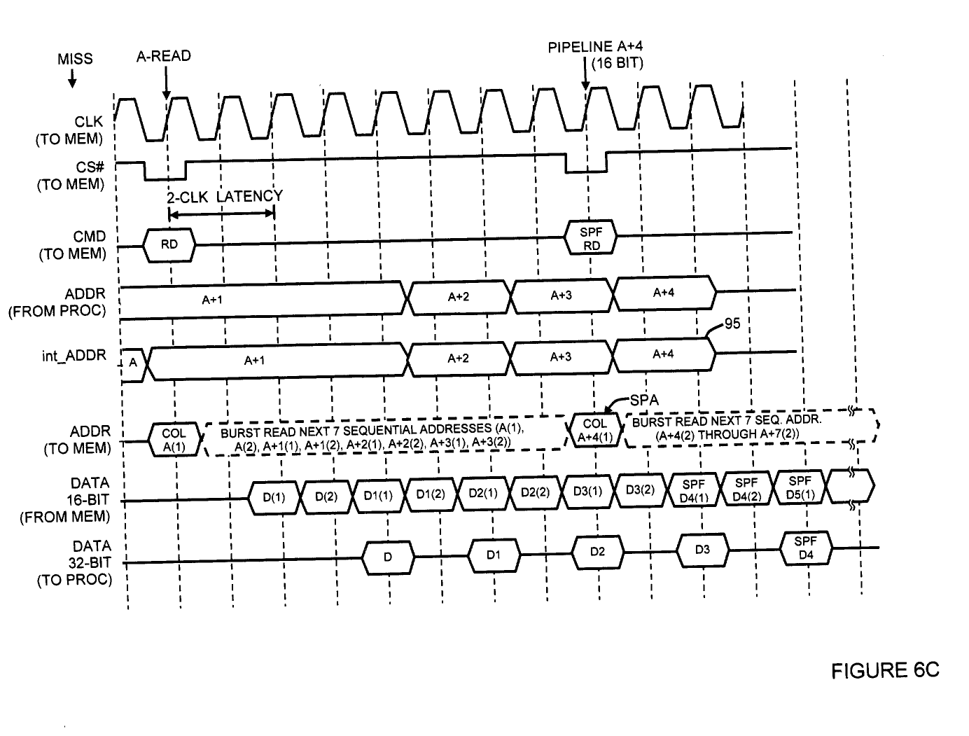

The super predictive fetch (SPF) of data which is carried out in the above steps can be better appreciated upon consideration of the illustrative diagram of FIG. 6A. Each of the blocks in FIG. 6A denotes a memory location in external memory 76 corresponding to a word of data. When step 104 of FIG. 5 is initiated, a four-word line of data beginning at address A is read from external memory 76 in a burst read. This four-word line contains the current requested data, (D), that resides at address A. During this read operation it is determined in step 106, FIG. 5, that the next address, (NA), is a sequential address, e.g. A+1. This is depicted in FIG. 6A where the block having address A+1 is located at the address next to the block having address A. With a sequential access being suggested by the sequential nature of addresses A and A+1, and assuming that step 114, FIG. 5, reveals that the next line of data beginning at SPA, is not in cache 70, step 116 initiates the super predictive fetch (pipelined burst read) of SPA. This is shown in FIG. 6A by the super predictive fetch of the four-word line that begins with address A+4.

FIG. 6B provides a timing diagram illustrating the above sequence that represents one example of the super predictive fetch of the invention. FIG. 6B shows a two-clock latency between the assertion of address A to memory, and the receipt of data D from memory. At the next clock following the sampling of A, the next address (A+1 in the illustrated case) becomes available from the processor and stays valid until data D is sampled by the processor. It is during this time that the next address is checked to see if it is sequential and the SPA determination is conducted. Since A+1 is a sequential address following A, FIG. 6B shows that at the end of the burst read of the line beginning at A, an SPA line address of A+4 is asserted to the memory as a pipelined burst read. The result of this pipelined burst read is shown two clock cycles later with the appearance of data D4, followed by D5, D6 and D7 from memory. Note that data D4 follows data D3, the last word in the line of data associated with D (the originally requested data). It is also to be noted that in the series of addresses being supplied to memory, the address A+1, A+2, and A+3 are, in effect, provided through the burst read operation. This is shown in dotted form to indicate that no additional addressing of memory (other than an advance-burst signal) is necessary to retrieve the corresponding data since such data was retrieved as a part of the line containing data D.

Thus, a super predictive fetch of data is performed so that data is retrieved in addition to the “next data” being indicated by the processor 52, and extends to a predicted “next line” of data in a sequential read. In the example illustrated in FIGS. 5, 6A, and 6B, the data retrieved in the super predictive fetch in accordance with the invention would correspond to a request from the processor that would be issued four (4) external memory 76 accesses after the current memory access.

Preferably, the SPA line of data retrieved in steps 116 and 104 in connection with the super predictive fetch is loaded or transferred into a super predictive buffer. This is handled in step 120, FIG. 5, following the completion of the external memory read in step 104. Step 120 also handles the transfer or loading into cache 70 of the line of data containing current requested data, D. Thus, in accordance with the invention, when a sequential read is suggested by the progression of addresses being supplied by the processor 52, multiple lines of data (two lines, in this example) are retrieved from external memory 76 and made available to the processor 52 through the cache subsystem 66 and 70.

It is to be noted that the SPA “next line” of data that is retrieved in connection with the super predictive fetch is not placed immediately into the cache 70, but instead is temporarily stored in a super predictive buffer. The cache controller 66 examines this buffer in step 98 of FIG. 5 to determine whether the data being sought can be found in the buffer. In this way, cache memory 70 will not be loaded with the SPA “next line” of data retrieved as a result of step 116 until it is determined that the data will actually be or is being requested by the processor. As can be appreciated from the above discussion, when the external memory request sequence from the processor 52 is not sequential, despite the processor 52 having issued two sequential address requests, the super predictive buffer will more than likely be cleared in step 102 on the next cache “miss.” On the other hand, when the processor 52 is in fact performing a sequential access, the contents of the super predictive buffer will be transferred to cache once the accessing of the data in the current line has been completed, and the processor 52 calls for data in the “next line,” see step 100.

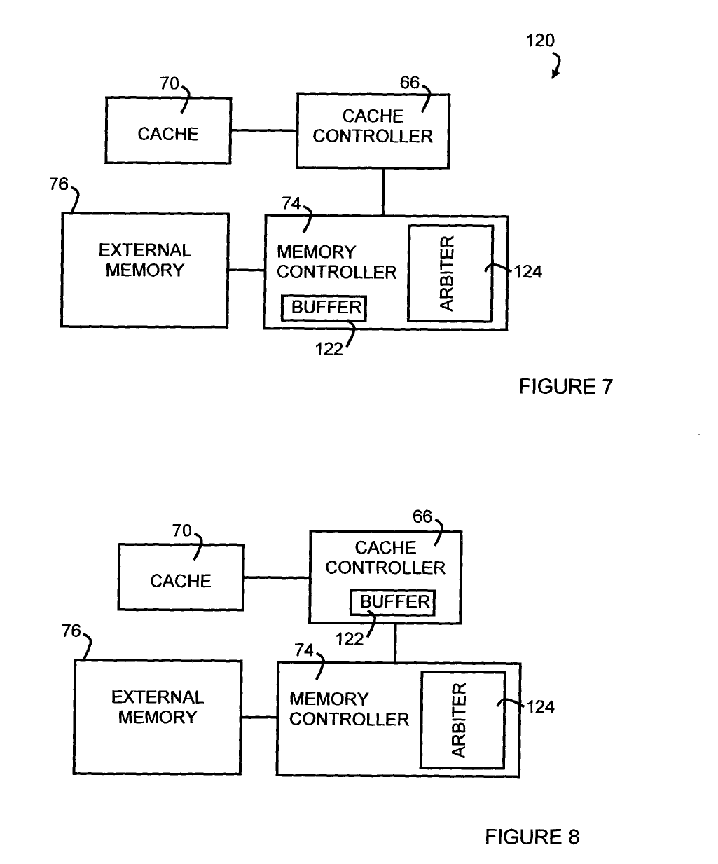

FIG. 7 illustrates a first embodiment of the super predictive fetch system 120 in accordance with the invention wherein a super predictive buffer 122 is located in the memory controller 74. In particular, during the super predictive fetch operation described above, the additional four (4) words of data are loaded into the buffer 122 in the memory controller. Then, if the data is requested by the processor, it is loaded into the cache 70 through the cache controller 66. In the alternative, the data is discarded if the data is not requested by the processor so that it is never loaded into the cache and time is not spent loading data into the cache that is not being used. Referring back to FIG. 4, each cache for each processor may include the buffer 122. Thus, in accordance with this embodiment of the invention, the memory controller 74 may include a buffer for the cache of the first processor as well as a buffer for the cache of the second processor. Now, a second embodiment of the invention will be described.

FIG. 8 illustrates a second embodiment of the super predictive fetch system 120 in accordance with the invention wherein a super predictive buffer 122 is located in the cache controller 66 as shown. The buffer operates in the same manner as described above. In this embodiment, the cache controller for each cache of each processor has the buffer.

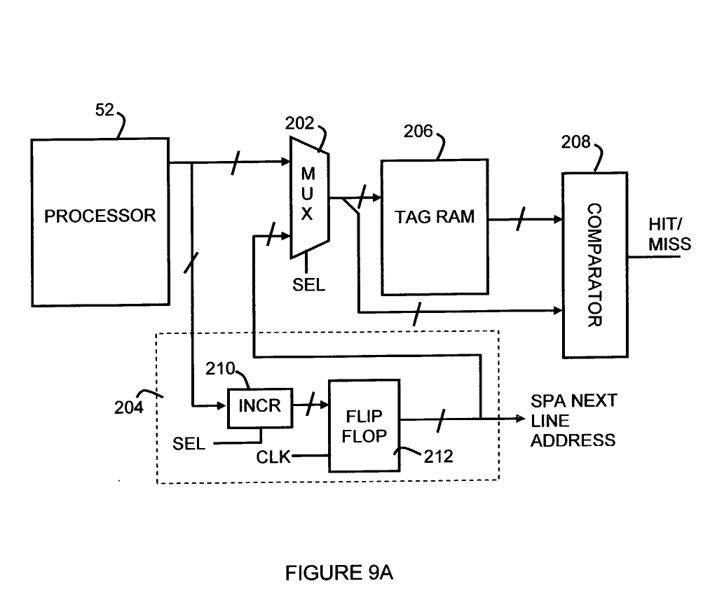

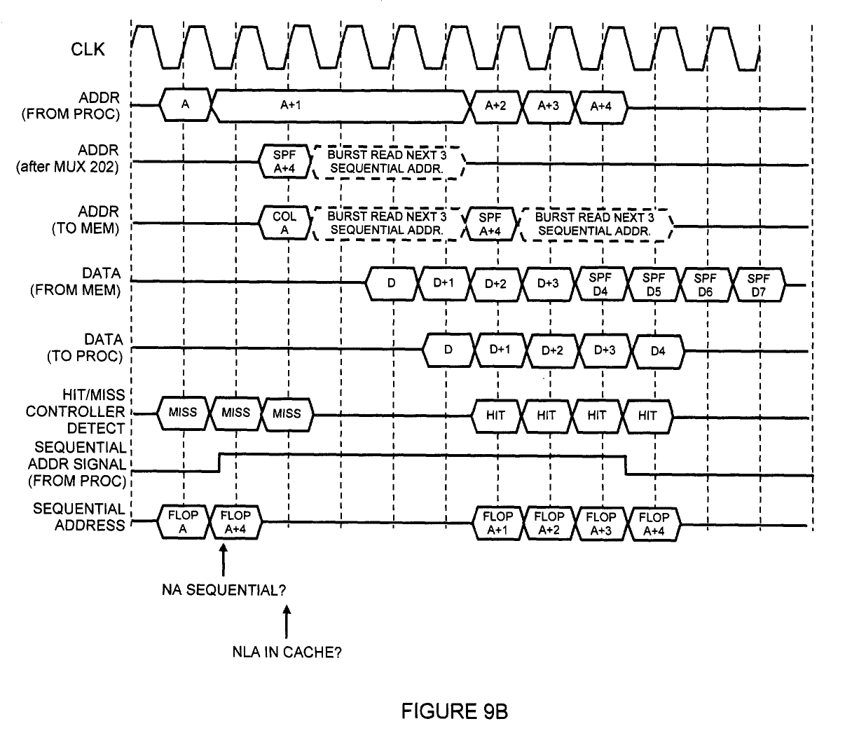

It is to be appreciated that the method and system of the invention does not cause a slow down in the cache processing because the invention performs its prediction processing and sequential access detection during the time over which the processor 52 would normally be waiting for data to be returned in response to an external memory access. This can be better appreciated upon examination of FIGS. 9A and 9B. FIG. 9A illustrates logic added to the cache processing path which can be used to implement the super predictive fetch SPA “next line” checking of the invention. FIG. 9B provides a diagram which illustrates the timing of the SPA “next line address” formation and cache checking.

In FIG. 9A it can be seen that the address for the current requested data is provided by processor 52 to a multiplexer 202 (MUX) and a latch (or flipflop) and incrementer circuit 204. The other input to multiplexer 202 receives the output from latch and incrementer circuit 204. The line address portion of the output of multiplexer 202 is applied to a tag RAM 206 which is a part of the cache controller 66 and cache memory 70. As explained above, a tag RAM uses the external memory address of the data currently stored in cache to provide a short hand look up to determine whether the cache contains the data of interest. Briefly, the tag RAM stores at a location designated by a first part (for example, the 5th through 18th bits) of the external memory address a second part of the external memory address (for example the 19th through 30th bits), for each of the data stored in the cache. In order to determine whether data at a particular external memory address is stored in cache, the tag RAM is addressed by the first part of the external memory address, and then a comparison is conducted between the second part of the external memory address and the output of the tag RAM. If there is a match, the data is present in the cache.

In FIG. 9A, the output of tag RAM 206 is compared in comparator 208 with a corresponding portion of the external memory address being supplied by multiplexer 202 to determine a “hit” or “miss” condition. Latch and incrementer circuit 204 stores the external memory address from processor 52, and also permits the address to be incremented to provide a “next line” address. Thus, if A is the address of the current line of data, and assuming a four-word line, the address for the SPA next line of data would be A+4, and the incrementer 210 would increment the address by four (4) to form the SPA next line address and the result would be latched in flip flop 212. Thereafter, following the check of the tag RAM 206 for the presence of the current requested data at address A, multiplexer 202 would be controlled to select the SPA “next line” address from latch and increment circuit 204 for input to the tag RAM 206. The other portion of the SPA “next line” is applied to the comparator 208 and the output of comparator 208 will indicate whether the SPA “next line” is present in cache.

From FIG. 9B it can be seen that on the first clock following the availability of address A, the address is latched in flip flop 212. Then on the next clock, during the time the “next address” (NA) is available and the processor is in a “wait state” mode, the processor (in an ARM processor implementation) will issue a signal indicating whether the next address is a sequential address. (Implementations not using ARM processors, or not having a comparable sequential address signal, may use comparator logic to compare the next address with the first address which has been incremented.) In FIG. 9B, the high state of the Sequential Address signal from the processor indicates a sequential next address. Thereafter, the SPA next line address is formed using incrementer 210 and latched into flip flop 212 so that it is available for selection by multiplexer 202.

The above described configuration for checking for the SPA next line address in cache is one possible implementation. In another possible implementation, instead of latching A and then incrementing the address, the address can be incremented first and then latched.

Another feature provided by the invention is a mechanism to determine whether retrieval of a particular SPA “next line” from external memory by the cache should be aborted. Additionally, as shown in FIGS. 7 and 8, the invention includes an arbiter 124 shown in this embodiment as being located in the memory controller 74. Arbiter 124 controls the priority of access by the various devices which may seek access to external memory. For example, as shown in FIG. 4, Device I or Device 2 may seek access to external memory 76 through the AHB bus and bridge 62. In the event one of the cache controllers is attempting a “next line” super predictive fetch, arbiter 124 is provided with rights to abort that super predictive fetch when a device of higher priority, such as Device 1 or Device 2, seeks to access external memory. Generally, the decision to terminate a “next line” super predictive fetch is based upon the degree of the penalty which will be incurred if the super predictive fetch were to continue. Thus, if no penalty will be involved, the super predictive fetch is permitted to continue to completion. If the penalty is many clock cycles, then the arbiter will terminate the super predictive fetch. It is to be understood that, as between a 32-bit memory subsystem and a 16-bit memory subsystem, there is a higher likelihood that a super predictive fetch will be terminated with the 16-bit subsystem. See FIG. 6C which illustrates the 16-bit case. This is because twice as many clock cycles are required to complete the reading of a line of data for the 16-bit memory subsystem, and thus the penalty, which can be incurred, will be greater.

It can also be appreciated from the above that the timing of the availability of the subsequent addresses from the processor can affect whether or not retrieval of the SPA “next line” of data will go forward. As can be seen in FIG. 6B, for the 32-bit memory subsystem case, the address A+4 (block 95) from the processor is shown appearing within a few clocks of the earliest point in time at which the SPA next line address A+4 (block 97) might be asserted by the cache controller to the external memory. If it turns out that the determination of the super predictive fetch SPA “next line address” is delayed such that the actual address from the processor is available, a determination can be made as to whether to proceed with the super predictive fetch, even if the prediction was incorrect. As with the case when other devices seek access to the external memory, the determination of whether to proceed or terminate a super predictive fetch when the prediction turns out to be incorrect, is determined according to the magnitude of the penalty that will be incurred. If no penalty will be incurred, then the super predictive fetch will be permitted to finish. If a large penalty will be incurred, the super predictive fetch will be aborted.

Thus, for the 16-bit example in FIG. 6C, the earliest point at which the cache controller can pipeline read the SPA line occurs just before the earliest point at which the address of block 95 can become available from the processor. In this case there is less of an opportunity to abort the super predictive fetch in the event the prediction was not correct.

As described above, a smaller cache granularity (such as four words as described above) results in a greater chance that the next data requested by the processor is not located in the cache for sequential address memory accesses. However, a larger cache granularity (such as 8 words) requires wider memory system bandwidth to load the eight (8) words into the cache. In addition, the larger fetch request results in more data being unused if the subsequent accesses are not sequential. The super predictive fetch operation in accordance with the example of the invention described, harmonizes these competing interests and provides the advantages of a four (4) word fetch request but provides a pseudo eight (8) word line fill which reduces the penalty associated with consecutive memory accesses.

While the foregoing has been with reference to a particular embodiment of the invention, it will be appreciated by those skilled in the art that changes in this embodiment may be made without departing from the principles and spirit of the invention, the scope of which is defined by the appended claims.

1. A data storage device comprising:
a cache;
a memory;
a memory controller coupled to said cache and said memory, wherein said memory controller supplies data corresponding to a next line of data when consecutive addresses of data being accessed from memory are sequential.

2. The data storage device of claim 1 further comprising a buffer for storing said next line of data.

3. The data storage device of claim 2 further comprising a cache controller coupled to said memory controller and said cache.

4. The data storage device of claim 2 wherein data from said buffer is transferred to said cache in response to a data read request for the data in said buffer.

5. The data storage device of claim 2 wherein said data in said buffer comprises data from a memory location having an address A+4, when said data read request is addressed to a memory location A.

6. The data storage device of claim 5 wherein said data in said buffer comprises data from a memory location having an address A+8.

7. The data storage device of claim 6 wherein said cache controller is coupled to an ARM processor.

8. The data storage device of claim 7 wherein said ARM processor is coupled to a cross-bar controller.

9. The data storage device of claim 8 wherein said cross-bar controller is coupled to a local memory.

10. The data storage device of claim 9 wherein said cross-bar controller is coupled to a coprocessor.

11. The data storage device of claim 10 wherein said cross-bar controller is coupled to an AHB bus.

12. A data storage device comprising:
a cache;
a cache controller coupled to said cache;
a buffer coupled to said cache controller;
a memory controller coupled to said cache controller; and
a memory coupled to said memory controller, said memory providing data to said buffer corresponding to a next line of data when consecutive addresses of data being accessed from memory are sequential.

13. The data storage device of claim 12 wherein said cache provides data when there is a data request for said data in said cache.

14. The data storage device of claim 13 wherein data in said buffer is forwarded to said cache when there is a data request for said data in said buffer.

15. The data storage device of claim 14 wherein said data in said cache comprises data from a memory location having an address A+4, when said data read request is addressed to a memory location A.

16. The data storage device of claim 15 wherein said data in said buffer comprises data from a memory location having an address A+8.

17. The data storage device of claim 16 wherein said cache controller is coupled to an ARM processor.

18. The data storage device of claim 17 wherein said ARM processor is coupled to a cross-bar controller.

19. The data storage device of claim 18 wherein said cross-bar controller is coupled to a local memory.

20. The data storage device of claim 19 wherein said cross-bar controller is coupled to a coprocessor.

21. The data storage device of claim 20 wherein said cross-bar controller is coupled to an AHB bus.

22. A method of caching data for use in conjunction with a memory and a cache, said method comprising:
receiving a data request having a memory address A;
determining whether said memory address is sequential to an address in a previous data request when said cache does not have data satisfying said data request; and
retrieving a next line of data based upon a line of data corresponding to the previous data request when said memory address is sequential to an address in the previous data request.

23. The method of claim 22 further including transferring the retrieved line of data from said memory to a buffer.

24. The method of claim 23 further comprising:
determining whether data in said buffer is requested or not;
discarding data in said buffer when said data in said buffer is not requested; and
transferring said data in said buffer to said cache when said data in said buffer is requested.

25. The method of claim 24 further comprising:
transferring data from said memory with a pipelined read when said memory address is not sequential to an address in a previous data request.

26. The method of claim 25 wherein said retrieving is performed for a memory address starting at A+4.

27. The method of claim 26 wherein a second retrieving operation is performed for a memory address starting at A+8.

28. The method of claim 27 wherein said data buffer is located in a cache controller coupled to said cache.

29. The method of claim 28 wherein said data buffer is located in a memory controller coupled to said memory.
